(19) United States
(12) Patent Application Publication
(10) Pub. No.: US 2004/0228433 A1
(43) Pub. Date: Nov. 18, 2004

(54) Neutron amplifier assembly

(75) Inventors: Joseph Magill, Karlsruhe (DE); Paolo Peerani, Leopoldshafen (DE)

Correspondence Address: SUGHRUE MION, PLLC, 2100 PENNSYLVANIA AVENUE, N.W., SUITE 800, WASHINGTON, DC, 20037, US

(73) Assignee: EUROPEAN COMMUNITY (EC)

(21) Appl. No.: 10/698,459

(22) Filed: Nov. 3, 2003

Related U.S. Application Data
(62) Division of application No. 09/958,905, filed on Oct. 15, 2001, now abandoned.
Application No. 09/958,905 is a 371 of international application No. PCT/EP00/03179, filed on Apr. 20, 1999.

(30) Foreign Application Priority Data
Apr. 20, 1999 (EP) 99107327.1

(51) Int. Cl. G21C 1/04

(52) U.S. Cl. 376/347

(57) ABSTRACT

A neutron amplifier assembly of the invention includes an array of fissile material which is subjected to a primary neutron flux. According to the invention a thin layer of fissile material is located on the inner surface of a hollow support cylinder of moderator material, the diameter of the cylinder being chosen such that the array is close to criticality.

This invention refers to a neutron amplifier assembly comprising a slightly subcritical array of fissile material which is subjected to a primary neutron flux.

A neutron flux is used not only for research purposes but also for irradiating goods, for cancer treatment and even for controlling a nuclear power generator. For example, a high neutron intensity above 10¹⁷ s⁻¹ would be useful for many purposes. Such a high flux is beyond the practical possibilities of modern accelerators, even in combination with a spallation target. It is therefore an object of the present invention to provide a neutron amplifier assembly which supplies an intense and readily controllable neutron flux.

This object is achieved according to the invention by the neutron amplifier assembly as defined in claim 1. For further improvements of this assembly reference is made to the secondary claims.

The invention will now be described in detail by means of some preferred embodiments and the enclosed drawings.

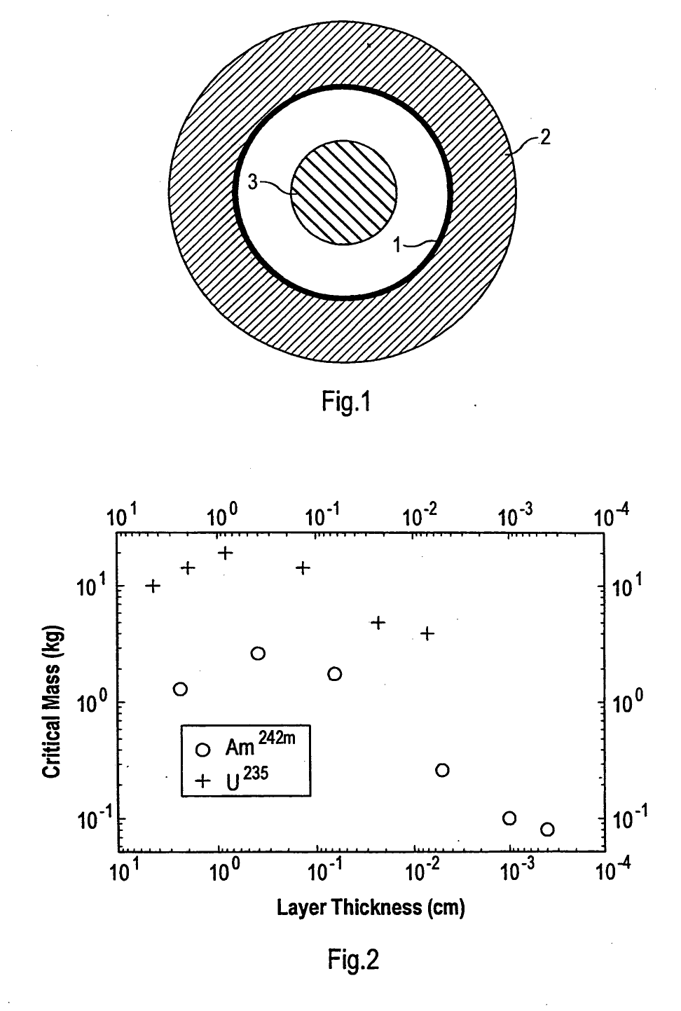

FIG. 1 shows schematically in cross-section a first embodiment of the assembly according to the invention.

FIG. 2 shows the relation between the mass and layer thickness of fissile material in the hollow cylindrical arrangement of given dimensions for k_{eff}=1.

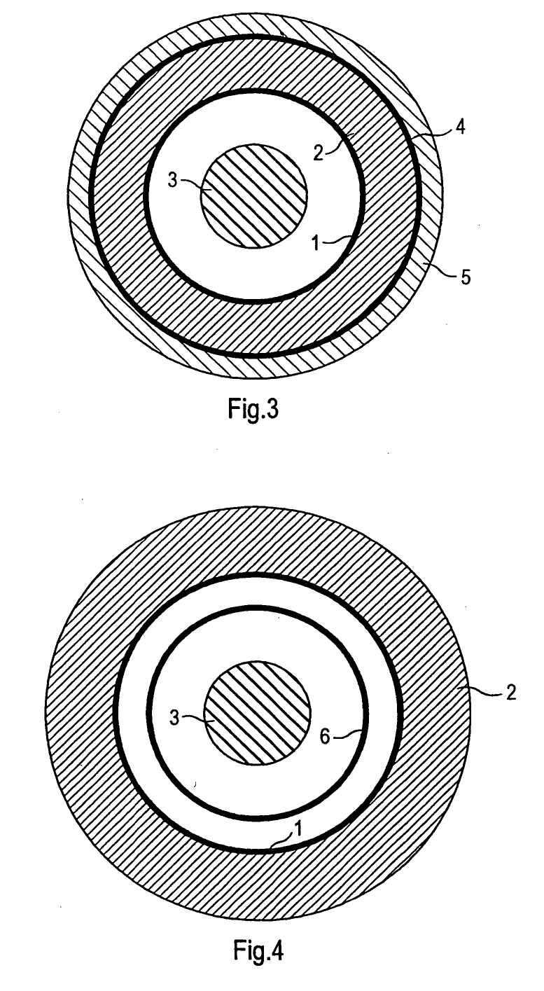

FIG. 3 shows a variant which is conceived to produce a high flux of fast neutrons.

FIG. 4 is an improved embodiment with two subcritical arrays in series.

According to a first embodiment shown in FIG. 1, the fissile material is Am²⁴². This material constitutes a thin layer 1 on the inner surface of a hollow cylinder 2 of circular cross-section, made of a neutron moderator material such as graphite or beryllium. Along the axis of this cylinder a spallation target 3 is located which is intended to receive a proton beam from an accelerator (not shown) along the axial direction of the cylinder 2. As an example, the cylinder height and its inner diameter are both 1 m, the diameter of the target 3 being 30 cm.

The thickness of the layer 1 is in the micrometer range and will be specified later. This thickness depends upon the type of fissile material and its concentration in this layer. In any case it must be sufficiently small in order to allow fast neutrons to pass therethrough without interaction, whereas thermal neutrons are trapped.

Neutrons starting from the target 3 may be either thermal or fast neutrons.

Thermal neutrons react immediately with the layer 1 and generate fast neutrons whereas fast neutrons pass there-through without interaction. In both cases fast neutrons penetrate into the graphite cylinder 2 and become thermalized. If these neutrons penetrate again into the layer 1 they cause more fissions. Those which escape from the cylinder at its outside constitute the output of the amplifier assembly.

It should be noted that the thickness of the fissile material layer on the inner surface of the graphite cylinder should be such that the arrangement does not become critical, but a criticality factor k_{eff} close to 1 should be achieved in order to enhance the neutron amplification gain.

The tables following hereafter show, for a cylinder having an inner diameter φ equal to its height, the thickness of a layer of Am^{242m} and U²³⁵ respectively required for various inner cylinder diameters φ necessary to make the system critical.

TABLE 1
Layer thickness of Am^{242m} metal and corresponding
mass required for critically for various cylinder diameters
φ.

| φ (cm) | critical thickness (cm) | critical mass (kg) |
|---|---|---|
| 10 | 0.4 | 2.6 |
| 20 | 0.063 | 1.6 |
| 30 | 0.005 | 0.25 |
| 40 | 0.001 | 0.1 |
| 60 | 0.0004 | 0.08 |

TABLE 2
Layer thickness of U²³⁵ metal and corresponding mass
required for critically for various cylinder diameters φ.

| φ (cm) | critical thickness (cm) | critical mass (kg) |
|---|---|---|
| 10 | 2 | 14 |
| 20 | 0.8 | 20 |
| 40 | 0.15 | 14 |
| 60 | 0.023 | 5 |
| 100 | 0.007 | 4 |

These values are also represented in the plot of FIG. 2 as small circles and crosses respectively. One can for example deduce therefrom that criticality is obtained with an Am^{242m} layer thickness of 4 μm on the inner surface (diameter 60 cm) of a graphite cylinder (axial length 60 cm). The overall critical mass of fissile material is under these circumstances only 80 g which is considerably less than the (bare) critical mass of a solid sphere of the same material (4.7 kg).

Thus if a thickness below 4 μm is chosen then the arrangement will be subcritical. If for example the criticality factor k_{eff} is 0.95 then its neutron amplification factor will become 20.

A commercial cyclotron supplying a proton beam of 150 MeV produces in a lead spallation target about 1 neutron per proton. Due to the layer of fissile material this neutron produces on average M neutrons where M≈1/(1−k_{eff}). For the case of k_{eff}=0.95, M is approximately 20.

The invention is not restricted to the embodiment described above. One could employ other fissile materials, such as U²³⁵ (see table 2 and FIG. 2). It should further be noted that the invention is also applicable to materials others than pure fissile materials, in which the fissile material is present in the layer at a substantially reduced amount.

It is also possible to cover the inner layer 1 of fissile material with a layer of moderator material in order to reduce damages in the fissile material layer due to high energy neutrons.

The neutron source can instead of a spallation target consist of a neutron emitter such as Californium.

The cylinder 2 is not necessarily of circular cross-section as shown in the drawings. In fact, the cross-section might be square or present an inner corrugated shape like a star. In this latter case the overall diameter of the cylinder 2 can be reduced whilst maintaining the same surface area of fissile material.

The heat production in the arrangement is rather low: Taking the above cited example of a 150 MeV accelerator supplying a proton current of 2 mA (corresponding to 300 kW power output) and a neutron amplification factor of 20 due to the layer 1 of fissile material, the neutron intensity will become about 2.5·10¹⁷s⁻¹. Since the neutron generation rate is approximately equal to the rate of fissioning, the maximum heat generation rate is about 8 MW. This heat can be easily extracted through coolant channels in the graphite cylinder.

In case that not a thermal neutron flux but a fast neutron flux is desired, the arrangement according to FIG. 1 should be completed, as shown in FIG. 3, by a further layer 4 of fissile material on the outer surface of the graphite cylinder 2 and optionally by a metal casing 5 around this layer, especially made of tungsten. This second layer 4 is again transparent to fast neutrons as it interacts only with neutrons which have been thermalized in the graphite cylinder. These neutrons cause fissions which result in fast neutrons. A part of these fast neutrons escapes through the casing whereas others return into the graphite cylinder and cause further fissions in one of the layers of fissile materials.

According to a further improvement of the present invention two or more layers of fissile material are located, preferably in a concentric axial configuration, between the spallation target and the inner diameter of the graphite cylinder. Such an example is sketched in FIG. 4. Here, one additional layer 6 of fissile material is added which is either self-supporting or deposited on a metal tube, for example made of tungsten (not shown).

As a further improvement, one or more moderator rods (not shown) can be inserted in a controlled manner into the free space inside the graphite cylinder. This insertion increases the criticality factor and allows a fine control of the neutron amplification factor and of the criticality factor, in order to take into account inhomogeneities of the thin layers and their burn-up.

What is claimed is:

1. An amplifier assembly for producing an amplified flux of neutrons, said assembly comprising:
a hollow support cylinder of moderator material, said hollow support cylinder having an inner surface and an outer surface;
a first thin layer of fissile material on said inner surface of said hollow support cylinder;
a neutron source within said hollow support cylinder for releasing a primary flux of neutrons that is received by said first thin layer of fissile material on said inner surface of said hollow support cylinder, said primary flux of neutrons comprising fast and/or thermal neutrons;
wherein said first thin fissile material layer has a thickness chosen to trap thermal neutrons but to allow fast neutrons to pass there-through without interaction, and said hollow support cylinder with said first thin layer of fissile material is dimensioned to achieve a criticality factor k_{eff} close to 1, so as to obtain a desired neutron amplification gain without risking to become critical, whereby said assembly produces an amplified flux of neutrons consisting of neutrons escaping through said outer surface of said hollow support cylinder.

2. The assembly according to claim 1, wherein:
said neutron source is a spallation target located along the axis of said hollow support cylinder, and
said assembly further comprises an accelerator capable of directing a proton beam axially through said hollow support cylinder onto said spallation target.

3. The assembly according to claim 1, wherein said neutron source is an intense spontaneous neutron emitter.

4. The assembly according to claim 1, wherein said criticality factor k_{eff} is about 0.95.

5. The assembly according to claim 1, comprising at least one second thin layer of fissile material, which is arranged in a concentric axial configuration between said first thin layer and said neutron source, wherein said hollow support cylinder with said first and second thin layer of fissile material is designed to achieve a criticality factor k_{eff} close to 1, so as to obtain a desired neutron amplification gain without risking to become critical.

6. The assembly according claim 5, wherein said second thin layer is self-supporting.

7. The assembly according claim 5, wherein said second thin layer is deposited on a metal tube.

8. The assembly according claim 1, wherein said moderator material is graphite.

9. The assembly according claim 1, comprising a thin outer layer of fissile material on said outer surface of said hollow support cylinder, said thin outer layer having a thickness chosen to trap thermal neutrons but to allow fast neutrons to pass there-through without interaction, whereby said amplified flux of neutrons consists only of fast neutrons escaping through said outer layer of fissile material.

10. The assembly according claim 1, wherein said hollow support cylinder includes coolant channels.

11. The assembly according claim 1, wherein said first thin layer of fissile material is covered with an internal layer of moderator material.

12. The assembly according claim 1, wherein said fissile materials comprise AM^{242m} or U²³⁵.

13. The assembly according claim 1, comprising at least one rod of moderator material movably inserted in a free space inside said hollow cylinder so as to be able to control said criticality factor.

14. The assembly according to claim 3, wherein said intense spontaneous neutron emitter is Californium.
